(19) United States
(12) Patent Application Publication
(10) Pub. No.: US 2026/0368914 A1
(43) Pub. Date: Nov. 19, 2026

(54) INFORMATION PROCESSING APPARATUS AND INFORMATION PROCESSING METHOD

(71) Applicant: CANON KABUSHIKI KAISHA, Tokyo (JP)

(72) Inventor: Yuika MATSUSHITA, Tokyo (JP)

(21) Appl. No.: 19/671,313

(22) Filed: May 8, 2026

(30) Foreign Application Priority Data
May 15, 2025 (JP) 2025-082122

(51) Int. Cl. G06T 7/593

(52) U.S. Cl. CPC G06T 7/593; G06T 2207/10012; G06T 2207/30252

(57) ABSTRACT

An information processing apparatus includes an acquisition unit that acquires a first distance map indicating first distance information corresponding to a position in a captured image and a second distance map indicating second distance information corresponding to a position in the captured image and a generation unit that generates a third distance map based on the first distance information of the first distance map and the second distance information of the second distance map.

### BACKGROUND

### Field of the Technology

The present disclosure relates to a technical field of generating distance information of a subject from a captured image.

### Description of the Related Art

There is known processing of acquiring distance information of a subject from an image captured by an image capture apparatus, and detecting an object in front of a vehicle using a distance map indicating distance information corresponding to a position in the captured image or blurring the background region of a main subject. To acquire distance information, various methods such as a stereo ranging method using a plurality of image capture apparatuses and the Time of Flight (ToF) method can be used. However, if a single method is used, it is difficult to acquire dense and accurate distance information corresponding to a captured image. On the other hand, a patent literature proposes a method of acquiring a dense and accurate distance map by combining depth information estimated from a captured image by machine learning such as deep learning using a trained artificial intelligence (AI) model and distance information acquired from LiDAR.

Prior Art Literature: J. Qiu, et al., "DeepLiDAR: Deep Surface Normal Guided Depth Prediction for Outdoor Scene From Sparse LiDAR Data and Single Color Image", Computer Vision and Pattern Recognition, 2019.

When an image capture apparatus and LiDAR are arranged at different positions and the image capture apparatus and the LiDAR have a parallax, like the prior art literature, it is sometimes impossible to generate a dense and accurate distance map corresponding to a captured image.

### SUMMARY

The present disclosure has been made in consideration of the aforementioned problems, and provides technical advantages for enabling generation of a dense and accurate distance map.

In order to solve the aforementioned problems, the present disclosure is directed to an information processing apparatus comprising: at least one processor; and at least one memory which stores a program which, when executed by the at least one processor, causes the information processing apparatus to function as: an acquisition unit that acquires a first distance map indicating first distance information corresponding to a position in a captured image and a second distance map indicating second distance information corresponding to a position in the captured image; and a generation unit that generates a third distance map based on the first distance information of the first distance map and the second distance information of the second distance map.

According to the present disclosure, it is possible to generate a dense and accurate distance map.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view showing the configuration of a system according to a first embodiment;

FIG. 2 is a block diagram exemplifying the configuration of an image capture apparatus according to the first embodiment;

FIG. 3 is a block diagram exemplifying the configuration of an information processing apparatus according to the first embodiment;

FIGS. 4A to 4D are flowcharts exemplifying processing of an extraction unit, a calculation unit, and a generation unit of the information processing apparatus according to the first embodiment;

FIGS. 5A to 5D are flowcharts exemplifying detailed processing of the extraction unit and the calculation unit of the information processing apparatus according to the first embodiment;

FIGS. 6A and 6B are views illustrating effective region setting processing shown in FIG. 5A;

FIG. 7 is a view illustrating local variation calculation processing shown in FIG. 5B;

FIGS. 8A to 8D are views illustrating background value region search processing and data extraction processing for background value region elimination shown in FIG. 5C;

FIG. 9 is a block diagram exemplifying the configuration of an image capture apparatus according to a second embodiment;

FIG. 10 is a view exemplifying the configuration of an imaging unit according to the second embodiment;

FIG. 11 is a sectional view exemplifying the configuration of a pixel of the imaging unit according to the second embodiment;

FIGS. 12A to 12E are views illustrating an imaging-plane phase difference detection method according to the second embodiment;

FIG. 13 is a flowchart exemplifying data extraction processing of a depth map according to the second embodiment; and

FIG. 14 is a view illustrating main subject region search processing according to the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### FIRST EMBODIMENT

In the first embodiment, a system in which an image capture apparatus and an information processing apparatus are mounted in a vehicle, an image on the front side of the vehicle is captured by the image capture apparatus, and distance information from the captured image to a subject is generated by the information processing apparatus will be described.

### SYSTEM CONFIGURATION

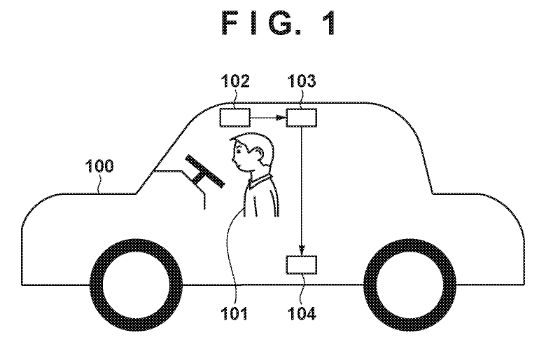

FIG. 1 is a view showing the configuration of a system according to a first embodiment.

A vehicle 100 is a moving apparatus such as an automobile. However, this is not limited to an automobile, and various kinds of public transportations such as a train and an airplane, small mobilities, or various kinds of robots such as an Automatic Guided Vehicle (AGV) may be used.

An image capture apparatus 102 is an in-vehicle camera that is arranged near the center of the upper end of the windshield of the vehicle 100 and captures an image in a predetermined range (to be referred to as an image capture enable range hereinafter) in front of the vehicle 100. The image capture apparatus 102 generates, from a captured image of the same viewpoint and the same time acquired by capturing an image of the ambient environment including the traveling road of the vehicle 100, a distance map indicating the distance from the image capture apparatus 102 to a subject and a depth map indicating the position of the subject in the depth direction in the captured image and outputs these to an information processing apparatus 103.

The information processing apparatus 103 extracts reliable data from the distance map (first distance map) and the depth map (second distance map) acquired from the captured image of the same viewpoint and the same time acquired from the image capture apparatus 102 and composites these, thereby generating a dense and accurate composited distance map (third distance map) and outputting this.

A vehicle control apparatus 104 performs drive control of the vehicle 100 or object detection notification to a driver 101 using the composited distance map generated by the information processing apparatus 103.

The image capture apparatus 102 is a digital camera or a digital video camera. The information processing apparatus 103 is an in-vehicle sensor device or a robot vision sensor device.

### CONFIGURATION OF IMAGE CAPTURE APPARATUS 102

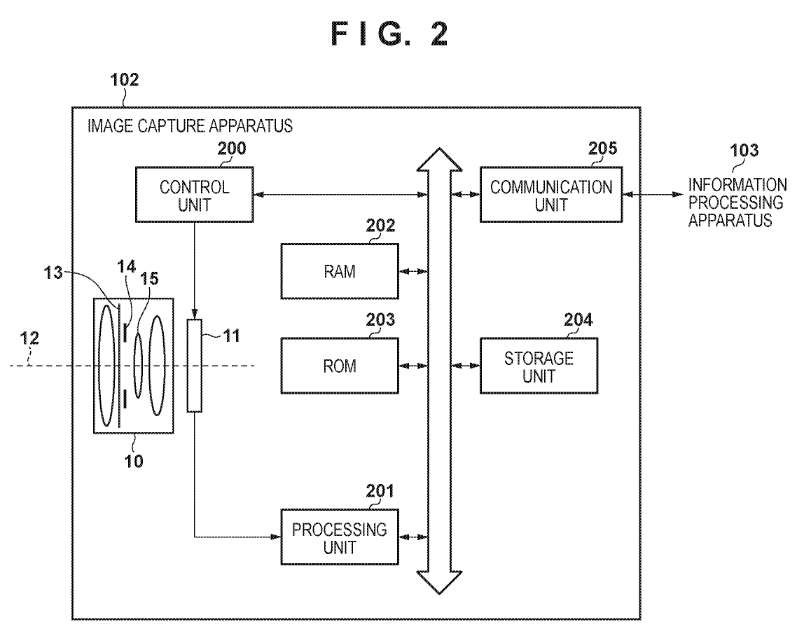

The configuration of the image capture apparatus 102 will be described next with reference to FIG. 2.

An imaging optical system 10 forms an optical image of a subject on the imaging plane of an imaging unit 11. The imaging optical system 10 includes a plurality of lenses arrayed along an optical axis 12. The plurality of lenses include a focus lens 15 configured to adjust the focal distance of the imaging optical system 10. The focus lens 15 can move along the optical axis. The focus lens 15 is driven by a control unit 200 in accordance with a defocus amount generated by a processing unit 201.

The imaging optical system 10 includes a stop 14 capable of adjusting the f-number (opening amount). The control unit 200 controls the f-number of the stop 14 based on, for example, an image capture condition determined by automatic exposure control (AE). An exit pupil 13 is an image of the open diaphragm of the imaging optical system 10 viewed from the imaging unit 11, and the position of the exit pupil 13 is exemplified in FIG. 2.

The imaging unit 11 includes an image sensor such as a CCD or a CMOS including color filters in, for example, a primary color Bayer array. The imaging unit 11 includes a pixel array in which a plurality of pixels are two-dimensionally arrayed and peripheral circuits configured to read out signals from the pixels. Each pixel accumulates charges according to the incident light amount by photoelectric conversion. A signal having a voltage according to the amount of charges accumulated during an exposure period is read out from each pixel, thereby acquiring a pixel signal group (analog image signal) representing a subject image the imaging optical system 10 forms on the imaging plane.

The pixel provided in the imaging unit 11 includes a plurality of photoelectric conversion regions or photoelectric conversion elements and can generate a parallax image pair by one image capture. Based on the parallax image pair, automatic focus control (phase difference AF) by automatic focus detection using a phase difference method can be executed, or distance information can be generated. Details will be described later in the second embodiment.

The control unit 200 includes one or more processors such as a CPU capable of executing a program. The processor of the control unit 200 loads a program stored in, for example, a ROM 203 into a RAM 202, executes it, and thus controls the constituent elements of the image capture apparatus 102, thereby implementing each function of the image capture apparatus 102.

The processing unit 201 applies predetermined image processing to an analog image signal read out from the imaging unit 11, thereby generating a signal or image data according to an application purpose or acquiring and/or generating various kinds of information. The processing unit 201 is, for example, a dedicated hardware circuit such as an Application Specific Integrated Circuit (ASIC) designed to implement a specific function. Alternatively, in the processing unit 201, a specific function may be implemented by a processor such as a Digital Signal Processor (DSP) or a Graphics Processing Unit (GPU) executing software. The processing unit 201 outputs acquired or generated information to the control unit 200 or stores it in the RAM 202 in accordance with the application purpose.

The processing unit 201 can also read out data stored in a storage unit 204 and process it.

Processing that the processing unit 201 can apply includes, for example, preprocessing, color interpolation processing, correction processing, data processing, special effect processing, distance map generation processing, and depth map generation processing.

Preprocessing includes, for example, A/D conversion, signal amplification, reference level adjustment, and defective pixel correction.

Color interpolation processing is processing that is performed when the image sensor includes color filters, and interpolates the values of color components not included in each pixel data of image data. The color interpolation processing is also called demosaic processing.

Correction processing includes, for example, white balance adjustment, tone correction, correction (image recovery) of image degradation caused by the optical aberration of the imaging optical system 10, correction of the influence of vignetting of the imaging optical system 10, and processing of color correction.

Data processing includes, for example, region cutting (trimming), compositing, scaling, encoding and decoding, header information generation (data file generation), and processing of generating display image data or recording image data.

Special effect processing includes, for example, addition of a blur effect, change of hue, and processing of relighting.

In distance map generation processing, a distance map is generated from an image pair with a parallax acquired by the imaging unit 11.

In depth map generation processing, inference processing of estimating a depth map from a captured image by machine learning such as deep learning using a trained artificial intelligence (AI) model is performed. The AI model is formed by, for example, a Convolutional Neural Network (CNN), but is not limited to the CNN and may be formed by a neural network such as Transformer.

In the inference processing, for example, a GPU is used, but a Field Programmable Gate Array (FPGA) may be used in place of the GPU. Also, the inference processing may be performed by cooperation of a CPU and a GPU or a DSP, or may be performed by either a GPU or a DSP.

Note that the above-described processing is merely an example of processing that the processing unit 201 can apply and is not intended to limit the processing that the processing unit 201 applies.

The RAM 202 is used as a work memory that holds a program to be executed by the CPU of the control unit 200 or the processor of the processing unit 201 and data necessary during execution of the program or a buffer memory configured to store image data acquired by the imaging unit 11 or image data processed by the processing unit 201.

The ROM 203 is, for example, a rewritable nonvolatile memory and stores a program that can be executed by the CPU of the control unit 200, a set value, a Graphical User Interface (GUI), and the like.

The storage unit 204 is a recording medium configured to record a data file storing image data acquired by the imaging unit 11. The storage unit 204 may be, for example, a combination of a memory card and a reader/writer therefor. The storage unit 204 may be able to handle a plurality of recording media.

A communication unit 205 is an interface that communicates with an external apparatus. The control unit 200 can perform communication complying with one or more wired standards with the external apparatus via the communication unit 205.

### CONFIGURATION OF INFORMATION PROCESSING APPARATUS 103

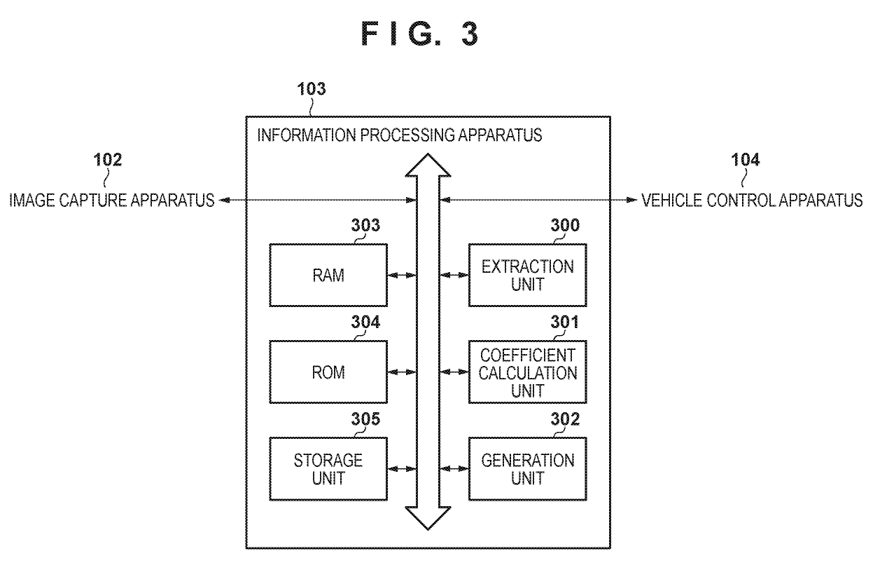

The configuration of the information processing apparatus 103 according to this embodiment will be described next with reference to FIG. 3.

An extraction unit 300 extracts the data of a highly reliable ranging value from the distance map acquired by the image capture apparatus 102. In addition, the extraction unit 300 extracts the data of a highly reliable depth value from the depth map acquired by the image capture apparatus 102. Here, "highly reliable" indicates that the reliability of a reliability determination target is not less than a predetermined threshold. This also applies to the following description.

A coefficient calculation unit 301 calculates a coefficient used to make scales match between the highly reliable ranging value and the highly reliable depth value extracted by the extraction unit 300.

A generation unit 302 performs scaling of, using the coefficient acquired by the coefficient calculation unit 301, converting the scale of the depth value of the depth map and making it match the scale of the ranging value of the distance map and composites the scaled depth map (data at a dense position) with the distance map (data at a coarse position), thereby generating a composited distance map.

The extraction unit 300, the coefficient calculation unit 301, and the generation unit 302 may each be, for example, a dedicated hardware circuit such as an Application Specific Integrated Circuit (ASIC) designed to implement a specific function. Alternatively, in each of the extraction unit 300, the coefficient calculation unit 301, and the generation unit 302, a specific function may be implemented by a processor such as a Digital Signal Processor (DSP) or a Graphics Processing Unit (GPU) executing software.

The extraction unit 300, the coefficient calculation unit 301, and the generation unit 302 each store acquired or generated information or data in a RAM 303 or the like in accordance with the application purpose.

A ROM 304 is a memory similar to the ROM 203 incorporated in the image capture apparatus 102. Also, the RAM 303 is used as a work memory or the like by the extraction unit 300, the coefficient calculation unit 301, and the generation unit 302.

A storage unit 305 is a recording medium configured to record a data file storing image data acquired by the imaging unit 11. The storage unit 305 may be, for example, a combination of a memory card and a reader/writer therefor. The storage unit 305 may be able to handle a plurality of recording media.

### DISTANCE MAP AND DEPTH MAP

The distance map and the depth map according to this embodiment will be described.

The distance map is generated using a captured image and has data of a ranging value indicating the distance information of a subject at a coarse position in an image. Also, the distance information indicates the actual distance from the image capture apparatus 102 to the subject or parallax information or defocus information equivalent to it. Also, the depth map is generated using the same captured image as the distance map and has data of a depth value indicating the distance information of the subject at a dense position in the image. Note that the distance information is information that shows the distance relationship of a subject in an image (the positional relationship in the depth direction) and need only be information that shows not the actual distance but a relative distance.

As described above, the resolution of the depth map is higher than the resolution of the distance map. In addition, the scale of the distance map and that of the depth map are different. For example, in the distance map, the unit of a distance is [m]. In the depth map, the unit of a distance is [au (astronomical unit)]. Note that the distance map and the depth map need not always have different scales, and may have the same dimensions if these are acquired from the same captured image using different methods.

### PROCESSING OF INFORMATION PROCESSING APPARATUS 103

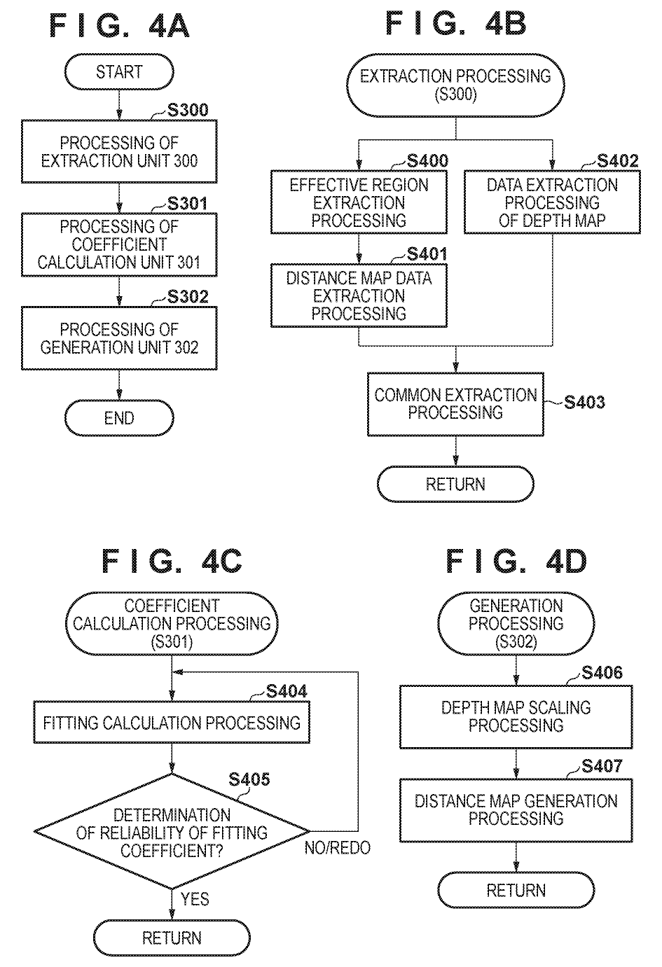

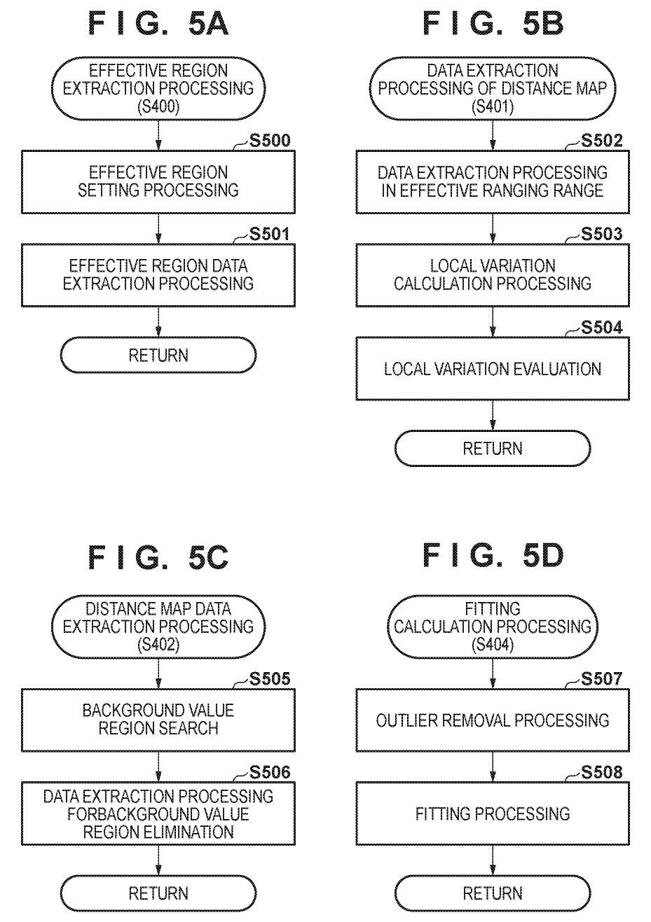

Processing executed by the information processing apparatus 103 according to this embodiment will be described next with reference to FIGS. 4A to 4D and FIGS. 5A to 5D.

FIGS. 4A to 4D are flowcharts exemplifying processing of the extraction unit, the calculation unit, and the generation unit of the information processing apparatus 103 according to the first embodiment. FIGS. 5A to 5D are flowcharts exemplifying detailed processing of the extraction unit and the calculation unit of the information processing apparatus 103 according to the first embodiment.

The processing shown in FIGS. 4A to 4D is executed every time a captured image and distance information are acquired in the image capture apparatus 102.

Processing of the information processing apparatus 103 will be described first with reference to FIG. 4A.

(Processing of Extraction Unit 300)

In step S300, the extraction unit 300 extracts data of a highly reliable ranging value from each of a distance map and a depth map acquired by the image capture apparatus 102 and stores the extracted data in the RAM 303.

FIG. 4B is a flowchart exemplifying detailed processing of step S300 in FIG. 4A.

In step S400, the extraction unit 300 extracts, in the distance map acquired by the image capture apparatus 102, a region having a highly reliable ranging value to be used in step S301 at the subsequent stage.

FIG. 5A is a flowchart exemplifying detailed processing of step S400 in FIG. 4B.

In step S500, the extraction unit 300 sets a highly reliable region in the distance map in consideration of a region including an effective ranging value according to the position of the image capture apparatus 102 and a region having a highly reliable ranging value based on the imaging optical system 10 and extracts the ranging value of the set region.

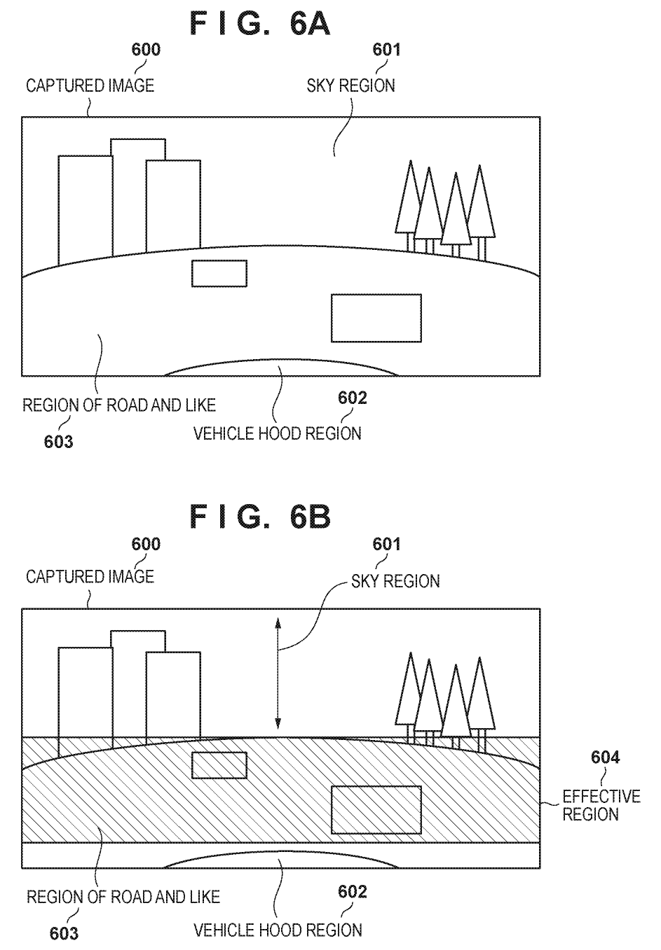

The effective region setting processing in step S500 in FIG. 5A will be described here with reference to FIGS. 6A and 6B.

A captured image 600 shown in FIG. 6A is an image acquired by the image capture apparatus 102, and a sky region 601, a vehicle hood region 602, and a region 603 of a road and the like are captured. In this case, the sky region 601 and the vehicle hood region 602 are ineffective regions because correct ranging cannot be performed there, and the remaining region 603 including the road and the like is set as an effective region 604 (X-1). FIG. 6B exemplifies a state in which the effective region is set in the captured image 600 shown in FIG. 6A.

Next, a highly reliable region derived from the imaging optical system 10 of the image capture apparatus 102 is set. More specifically, the ranging accuracy lowers in the vignetting region of the imaging optical system 10 or in the image peripheral portion if the optical system is wide-angled. Hence, using the image height of the captured image as a parameter, the image center portion is set as an effective region (X-2) in which a highly reliable ranging value can be acquired.

Note that the effective region setting method is not limited, and processing of removing a subject that is too close, processing of removing a subject that is traveling alongside the vehicle 100, processing of removing a subject floating in the air, or the like may be performed.

In step S501 of FIG. 5A, the extraction unit 300 extracts ranging values in the effective regions (X-1 and X-2) set in step S500 from the distance map of the image capture apparatus 102, and outputs the extracted effective region extraction distance map. After that, the process advances to step S401 in FIG. 4B.

In step S401, the extraction unit 300 extracts a ranging value in an effective ranging range for the effective region extraction distance map extracted in step S400.

FIG. 5B is a flowchart exemplifying detailed processing of step S401 in FIG. 4B.

In step S502, the extraction unit 300 evaluates whether the ranging value in the effective region extraction distance map extracted in step S400 falls within the effective ranging range, extracts more reliable ranging value data, and outputs the extracted effective ranging extraction distance map. The effective ranging range is set by the image capture apparatus 102 or the ranging accuracy. Also, the effective ranging range may be adjusted in accordance with the ambient environment at the time of image capture, for example, brightness outside the vehicle or the temperature in the vehicle, which changes during traveling of the vehicle.

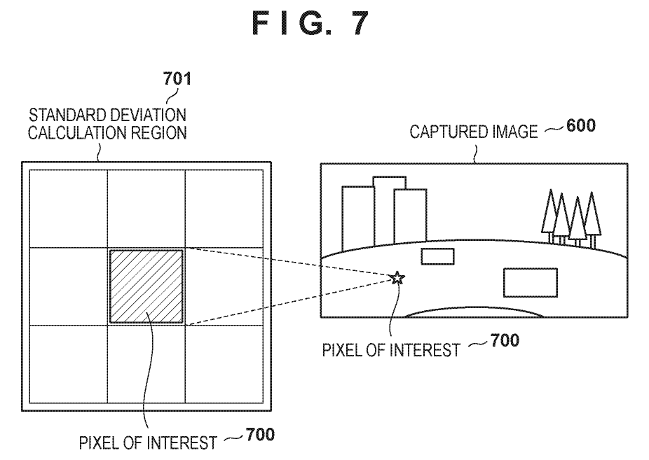

In step S503, the extraction unit 300 calculates a local variation of the ranging value of the effective ranging extraction distance map extracted in step S502. In a region where the variation of the ranging value is smaller than a predetermined range, the ranging error is small, and as for a local variation of a highly reliable (except for a region where subjects in far and near places coexist) ranging value, a pixel of interest in the distance map and a peripheral region including it are set, and calculation is performed using a standard deviation. For example, a pixel 700 of interest in a distance map as shown in FIG. 7 and a peripheral region (to be referred to as a standard deviation calculation region 701 hereinafter) surrounding the pixel 700 of interest are set, the standard deviation of the ranging value in the pixel region is calculated, and the acquired value is set as the local variation. Note that the standard deviation calculation region 701 used to calculate the local variation is not limited, and a region including the pixel 700 of interest suffices. In addition, the local variation calculation method is not limited, and it suffices that the variation can be calculated regardless of standard deviation or variance.

In step S504, the extraction unit 300 performs evaluation processing concerning the local variation data calculated in step S503, extracts data of a highly reliable ranging value whose reliability is not less than a predetermined threshold from the effective ranging extraction distance map acquired in step S502, and outputs the extracted distance map (to be referred to as an extraction distance map hereinafter). The threshold is set by the ranging characteristic of the image capture apparatus 102.

In parallel to the processes of steps S400 and S401 in FIG. 4B, the process of step S402 is executed.

In step S402, the extraction unit 300 extracts, in the depth map acquired by the image capture apparatus 102, a region having a highly reliable ranging value to be used in step S301 at the subsequent stage.

FIG. 5C is a flowchart exemplifying detailed processing of step S402 in FIG. 4B.

In step S505, the extraction unit 300 searches for a region having a depth value that can be considered as the background of the captured scene from the data of the depth value of the depth map, and sets a background value region. The background value region corresponds to the region of a value recognized as a background value by inference processing.

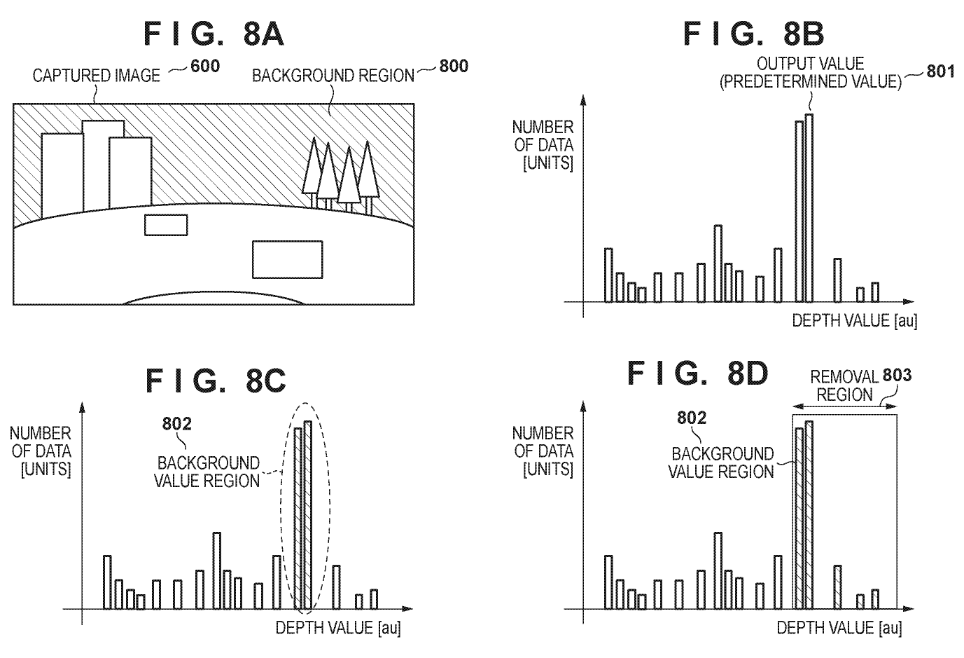

The background value region search method will be described here with reference to FIGS. 8A to 8C.

As the characteristic of the estimated depth value of the depth map acquired by inference processing, the region that can be considered as the background (a background region 800 indicated by a hatching portion in FIG. 8A) exhibits a predetermined value. FIG. 8B shows an example in which estimated depth values in a depth map for a captured image 600 shown in FIG. 8A are expressed as a histogram. As can be seen from FIG. 8B, the estimated depth value of a region that can be considered as the background is output as a predetermined value 801. It is considered that the reliability of the estimated depth value of the region that can be considered as the background is low, and the depth value is unnecessary in processing at the subsequent stage. Hence, a region surrounded by a dotted line in FIG. 8C is set as a background value region 802.

In step S506, the extraction unit 300 extracts the data of the depth map using the background value region 802 set in step S505, and outputs the extracted depth map (to be referred to as an extraction depth map hereinafter).

In data extraction processing for removing the background value region, removal of the background value region 802 set in step S505 and removal of the data of a region (to be referred to as a removal region 803 hereinafter) having a value larger than that in the background value region 802 are performed (see FIG. 8D). The depth value of the region having the value larger than that in the background value region is larger than the background value and is consequently considered as an outlier of the depth map. For this reason, in the data extraction processing for removing the background value region in step S506, the removal region 803 is removed, thereby extracting data.

Note that data to be extracted in step S300 of FIG. 4A is not limited, and extraction may be performed using more reliable data in at least one of the distance map and the depth map. Also, the timing of executing the extraction processing of step S300 is not limited, and more reliable data extraction may be performed in at least one of steps S400, S401, and S402 in FIG. 4B.

After the processes of steps S400, S401, and S402 in FIG. 4B, the process advances to step S403.

In step S403, the extraction unit 300 extracts data of a common region (to be referred to as common extraction data hereinafter) between the extraction distance map acquired in step S401 and the extraction depth map acquired in step S402.

Note that as for the extraction of the common extraction data, it can be acquired by a logical operation such as AND processing between the extraction distance map and the extraction depth map. Note that the common extraction data extraction method is not limited, and the extraction may be performed based on OR processing of any one of the extraction distance map and the extraction depth map or the ranging reliability of the extraction distance map and the extraction depth map.

The ranging reliability is a value that quantifies the reliability of the ranging value in the distance map. The ranging reliability is set for each pixel position in the distance map, and is calculated and set by, for example, the data of the contrast of the captured image, luminance, illuminance, exposure, brightness, temperature, humidity, and the like. The ranging reliability is stored in the RAM 202 and read out at the time of processing as needed.

After the process of step S403 in FIG. 4B, processing of the coefficient calculation unit 301 is performed in step S301 of FIG. 4A.

(Processing of Coefficient Calculation Unit 301)

In step S301, the coefficient calculation unit 301 calculates a coefficient used to make scales match between the highly reliable data of the distance map and that of the depth map acquired in step S300.

FIG. 4C is a flowchart exemplifying detailed processing of step S301 in FIG. 4A.

In step S404, the coefficient calculation unit 301 performs fitting using the common extraction data acquired in step S300 and outputs the acquired coefficient.

FIG. 5D is a flowchart exemplifying detailed processing of step S404 in FIG. 4C.

In step S507, the coefficient calculation unit 301 determines the validity of the common extraction data acquired in step S300 and removes data determined as invalid. The coefficient calculation unit 301 performs processing of removing the outliers of the common extraction data acquired in step S300 and outputs the common extraction data (to be referred to as common extraction data that has undergone outlier removal hereinafter) from which the outliers are removed. To remove the outliers of the common extraction data, Random Sample Consensus (to be referred to as RANSAC hereinafter) processing is employed. Note that the outlier removal method is not limited, and random sampling, systematic sampling, stratified sampling, cluster sampling, or the like may be used.

In step S507, the coefficient calculation unit 301 removes outliers of the distance map and the depth map, which cannot be removed by the extraction processing in step S300. When coefficient calculation is performed in preprocess of step S300 or in a halfway process, outliers in a state in which data extraction is insufficient are moved. Since the distance map and the depth map acquired by the image capture apparatus 102 have errors, it is difficult to complete outlier removal only in step S507 for the outliers output in a wide region. For this reason, it is impossible to achieve the same effect as the effect of step S507 before and after the process of step S300. Hence, as the timing of performing outlier removal, it is effective to perform outlier removal in the common extraction data after the process of step S300.

In step S508, the coefficient calculation unit 301 calculates a fitting coefficient of an approximate expression from the common extraction data that has undergone outlier removal.

Fitting is performed using an appropriate function in accordance with the depth value of the depth map acquired by the image capture apparatus 102. For example, if a relative value proportional to the reciprocal of the distance is output as the depth value of the depth map, fitting is performed using a linear function Y = AX + B, and a coefficient A and a coefficient B are acquired as the fitting coefficients. Note that the function expression used for fitting is not limited, and a function expression according to the depth value of the depth map acquired by the image capture apparatus 102 is used.

After the process of step S404 in FIG. 4C, the process advances to step S405.

In step S405, the coefficient calculation unit 301 determines the reliability of the fitting coefficient using the fitting coefficient calculated in step S404 and the threshold of the fitting coefficient, and outputs the calculated coefficient as a highly reliable coefficient. In the determination of the reliability of the fitting coefficient, a coefficient in the range of the threshold is directly output. When the coefficient is outside the range of the threshold, the process returns to step S404. The process of step S301 is repetitively performed until a coefficient that falls within the range of the threshold is calculated.

The threshold of the fitting coefficient is set from the distance map and the depth map acquired by the image capture apparatus 102. As for the threshold of the fitting coefficient, a highly reliable coefficient is set based on an index such as the ranging value of an obstacle located closest, a vanishing point on a road surface, or the tilt of a road surface in a coefficient handled when scaling the depth map at the subsequent stage.

After the process of step S405 in FIG. 4B, processing of the generation unit 302 is performed in step S302 of FIG. 4A.

(Processing of Generation Unit 302)

In step S302, the generation unit 302 generates a composited distance map using the distance map and the depth map acquired by the image capture apparatus 102 and the coefficients (the coefficient A and the coefficient B) calculated in step S301.

FIG. 4D is a flowchart exemplifying detailed processing of step S302 in FIG. 4A.

In step S406, the generation unit 302 performs scaling of the depth map using the depth map acquired by the image capture apparatus 102 and the coefficients calculated in step S301, and outputs a depth map in which the data of the depth value is scaled.

In step S407, the generation unit 302 generates a composited distance map using the scaling data of the depth map acquired in step S406. Note that the data used to generate the composited distance map is not limited, and the composited distance map may be generated using a plurality of data such as the distance map and the ranging reliability in addition to the depth map scaled in step S406.

As for the generation of the composited distance map, the data of the depth value scaled in step S406 is converted into data in a map format, thereby generating the composited distance map and outputting it. Note that the composited distance map generation method is not limited, and a method of generating the composited distance map by performing region division for the distance map and the scaled depth map based on the ranging reliability, a method of generating the composited distance map by changing the correction ratio for the distance map and the scaled depth map based on the ranging reliability, a method of correcting a data omission region of the distance map by the scaled depth map, or the like may be used.

As described above, according to the first embodiment, highly reliable data are extracted from distance information and depth information acquired from the same captured image of the same viewpoint and the same time, and the weaknesses of these data are compensated for while making use of their strengths, thereby generating an accurate and dense distance map. It is therefore possible to improve the accuracy of the composited distance map generated by the information processing apparatus 103 and increase the reliability of drive control of the vehicle. In addition, when the composited distance map output from the information processing apparatus 103 is input to the vehicle control apparatus 104, it is possible to control the vehicle 100 or notify the driver 101 of an obstacle.

On the other hand, in the prior art literature, the captured image of the image capture apparatus and the range image of the LiDAR have a time lag and a parallax, and the time axis direction and the ranging position do not synchronize. For this reason, it is sometimes impossible to generate dense and accurate distance information corresponding to the captured image.

Also, in an actual vehicle, distance information needs to be calculated in real time during traveling. When compositing distance information acquired from a parallax image pair and depth information estimated from a captured image, since the time axis direction and the ranging position need to be synchronized, the processing amount is excessive.

In this embodiment, however, since two or more pieces of distance information and depth information, which are acquired from the same captured image of the same viewpoint and the same time, are combined, the time axis direction and the ranging position need not be synchronized, and it is therefore possible to decrease the processing amount and shorten the processing time.

In this embodiment, since the ranging value and the captured image acquired from the parallax image pair are data acquired by one image capture processing (shutter release), it is possible to acquire reliable data of the same viewpoint and the same time. In this case, the depth value estimated from the captured image can easily be aligned with the ranging value by making the pixel positions match.

Note that in this embodiment, an example in which ranging is performed using an image sensor including imaging-plane phase difference detection pixels has been described, but the present disclosure is not limited to this. The embodiment can also be applied to a case where a stereo camera formed by two or more image capture apparatuses is used. In this case, it is possible to estimate a depth map based on a captured image of any one of the image capture apparatuses of the stereo camera as a reference and, like the embodiment, composite distance information and depth information.

Also, in this embodiment, an example in which a depth map is estimated from a captured image by inference processing using an AI model has been described, but the present disclosure is not limited to this. For example, a method using a contrast (blue) in a captured image as a key, a method using a vanishing point estimated from a line such as a road, a method using an object such as a sign having a known size, or a method of performing estimation by analyzing a captured image may be used.

### SECOND EMBODIMENT

In a second embodiment, a configuration example in which the image capture apparatus 102 and the information processing apparatus 103 according to the first embodiment are integrated into an image capture apparatus 901 will be described.

Note that in the second embodiment, the same reference numerals as in the first embodiment denote the same or similar components in the second embodiment, and a repetitive description thereof will be omitted.

The image capture apparatus 901 is a digital camera or a digital video camera.

### APPARATUS CONFIGURATION

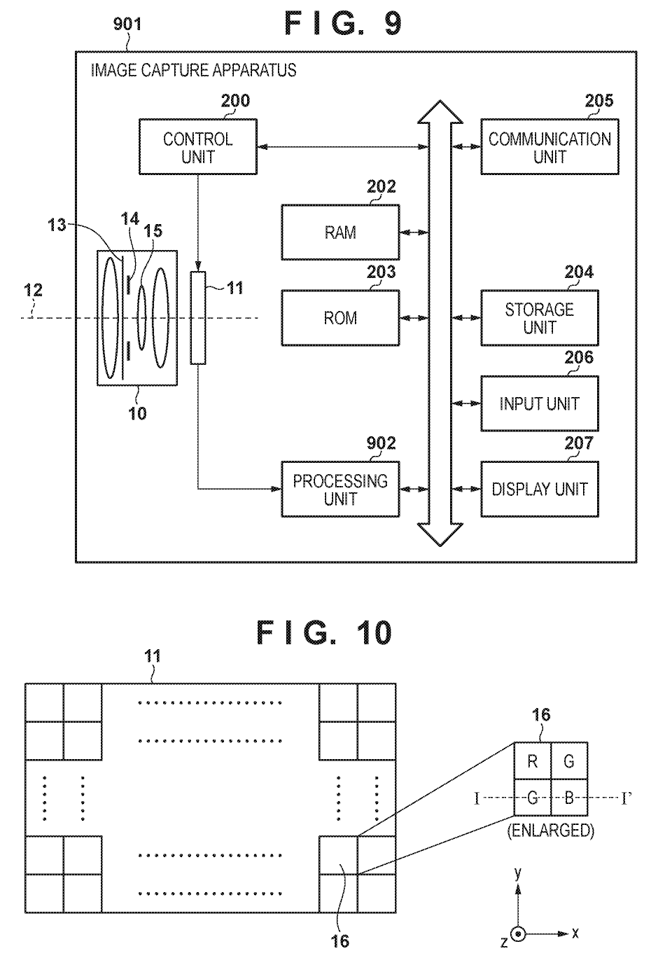

FIG. 9 is a block diagram exemplifying the configuration of the image capture apparatus 901 according to this embodiment.

An imaging optical system 10, an imaging unit 11, a control unit 200, a RAM 202, a ROM 203, a storage unit 204, and a communication unit 205 are the same as in FIG. 2 of the first embodiment.

Processing that a processing unit 902 applies includes edge detection processing, virtual camera position setting processing, virtual viewpoint image generation processing, and virtual viewpoint moving image generation processing, in addition to the processing according to the first embodiment. Processing that the processing unit 902 applies also includes the processing of an extraction unit 300, the processing of a coefficient calculation unit 301, and the processing of a generation unit 302 described in the first embodiment. That is, the processing unit 902 has the functions of the extraction unit 300, the coefficient calculation unit 301, and the generation unit 302 shown in FIG. 3. The extraction unit 300, the coefficient calculation unit 301, and the generation unit 302 may each be, for example, a dedicated hardware circuit such as an Application Specific Integrated Circuit (ASIC) designed to implement a specific function. Alternatively, in each of the extraction unit 300, the coefficient calculation unit 301, and the generation unit 302, a specific function may be implemented by a processor such as a Digital Signal Processor (DSP) or a Graphics Processing Unit (GPU) executing software.

An input unit 206 is an input device such as a dial, a button, a switch, or a touch panel that is provided on the image capture apparatus 901 and is operable by a user. An operation for the input unit 206 is monitored by the control unit 200. Upon detecting an operation for the input unit 206, the control unit 200 executes an operation corresponding to the function and the operation assigned to the operated input device.

A display unit 207 is a display device such as a liquid crystal display or an organic EL. When moving image capture and display of the captured moving image on the display unit 207 are continuously executed, the display unit 207 can be caused to function as an electronic viewfinder (EVF). The operation of causing the display unit 207 to function as an electronic viewfinder (EVF) is sometimes called live view display or through-the-lens display. In addition, an image displayed on the display unit 207 by live view display or through display is sometimes called a live view image or a through image.

The display unit 207 may be a touch display. If the display unit 207 is a touch display, software keys may be implemented by combining the touch panel and a GUI displayed on the display unit 207. The control unit 200 handles the software keys like the input devices included in the input unit 206.

### CONFIGURATION OF IMAGING UNIT

FIG. 10 is a plan view of the pixel array of the imaging unit 11 viewed from the imaging plane side.

Color filters of a primary color Bayer arrangement are provided in the pixel array. Any one of red (R), green (G), and blue (B) color filters is arranged on each pixel such that a pixel group 16 of 2 rows × 2 columns is repetitively periodically arranged. Note that color filters of an arrangement other than the primary color Bayer arrangement may be provided.

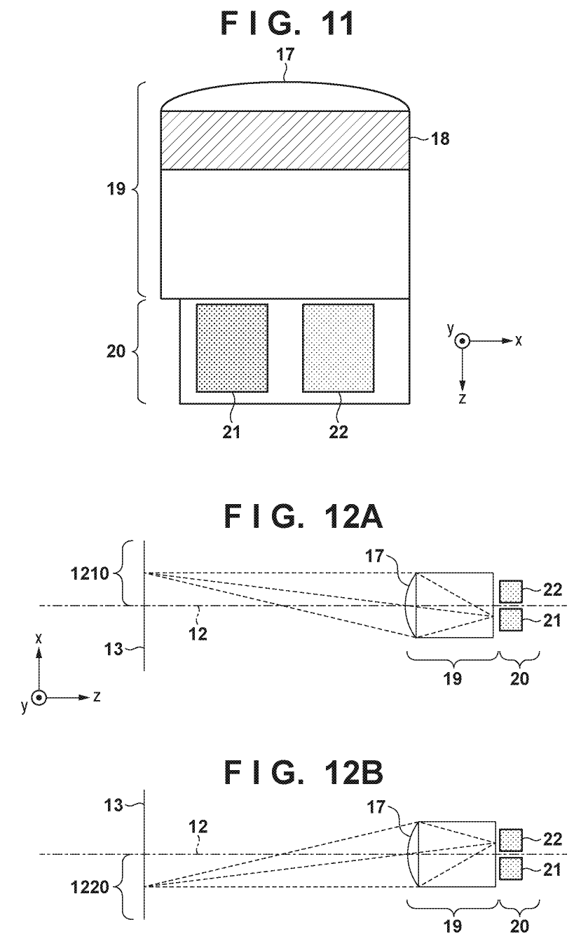

FIG. 11 is a vertical sectional view of one pixel corresponding to the structure of an I - I' section in FIG. 10.

Each pixel includes a light guide layer 19 and a light receiving layer 20. The light guide layer 19 includes one microlens 17 and a color filter 18. The light receiving layer 20 includes a first photoelectric conversion portion 21 and a second photoelectric conversion portion 22.

The microlens 17 is configured to efficiently guide a light beam that has entered the pixel to the first photoelectric conversion portion 21 and the second photoelectric conversion portion 22. Also, the color filter 18 corresponds to one of an R filter, a G filter, and a B filter.

Each of the first photoelectric conversion portion 21 and the second photoelectric conversion portion 22 generates a charge according to the incident light amount. The imaging unit 11 can selectively read out a signal from one or both of the first photoelectric conversion portion 21 and the second photoelectric conversion portion 22 of each pixel. In this embodiment, a description will be made, defining a signal acquired from the first photoelectric conversion portion 21 as an A signal, a signal acquired from the second photoelectric conversion portion 22 as a B signal, and signals acquired from both the first photoelectric conversion portion 21 and the second photoelectric conversion portion 22 as (A + B) signals.

Since the first photoelectric conversion portion 21 and the second photoelectric conversion portion 22 view an exit pupil 13 from different viewpoints, an image formed by the A signal and an image formed by the B signal read out from the same pixel region form a parallax image pair. By using the A signal and the B signal, a defocus amount can be acquired in accordance with a phase difference detection method. Hence, it can be said that the A signal and the B signal are focus detection signals.

On the other hand, the (A + B) signal corresponds to a signal acquired when a pixel includes one photoelectric conversion portion. Hence, when the (A + B) signal is acquired from each pixel, an analog image signal can be acquired.

Note that the A signal can also be acquired by subtracting the B signal from the (A + B) signal. Similarly, the B signal can also be acquired by subtracting the A signal from the (A + B) signal. Hence, when the (A + B) signal and the A signal or the B signal are read out from each pixel, the A signal, the B signal, and the (A + B) signal can be acquired. The types of signals to be read out from each pixel are controlled by the control unit 200.

Note that in the example shown in FIGS. 10 and 11, each pixel includes the two photoelectric conversion portions 21 and 22 arranged in the horizontal direction, but the present disclosure is not limited to this. For example, a total of four photoelectric conversion portions may be arranged, including two photoelectric conversion portions in the horizontal direction and two photoelectric conversion portions in the vertical direction. In addition, a plurality of pairs each including a dedicated pixel for generating the A signal and a dedicated pixel for generating the B signal may be distributedly arranged in the pixel array. The imaging unit 11 can have a known configuration corresponding to phase difference AF and an arbitrary configuration.

### IMAGING-PLANE PHASE DIFFERENCE DETECTION METHOD

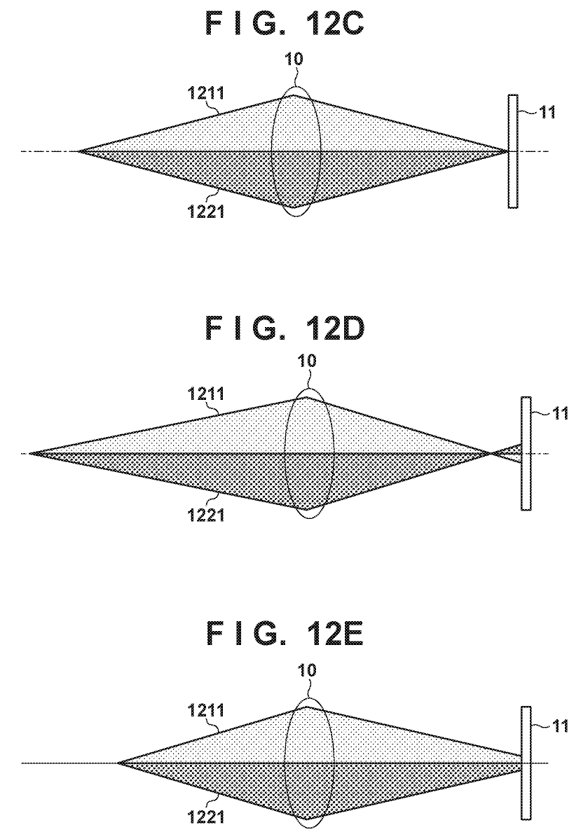

FIGS. 12A to 12E are views illustrating an imaging-plane phase difference detection method according to this embodiment.

The imaging-plane phase difference detection method is processing of calculating a defocus amount using the A signal and the B signal.

FIG. 12A is a schematic view showing the relationship between the exit pupil 13 of the imaging optical system 10 and a light beam that enters the first photoelectric conversion portion 21 of a pixel. FIG. 12B is a schematic view showing the relationship between the exit pupil 13 and a light beam that enters the second photoelectric conversion portion 22 of the same pixel.

Note that in this embodiment, a direction that is parallel to the optical axis of the imaging optical system 10 is defined as the z direction or the defocus direction, a direction that is orthogonal to the optical axis and parallel to the horizontal direction of the imaging plane is defined as the x direction, and a direction that is orthogonal to the optical axis and parallel to the vertical direction of the imaging plane is defined as the y direction.

The microlens 17 is arranged such that the exit pupil 13 and the light receiving layer 20 hold an optically conjugate relationship. A light beam that has passed through the exit pupil 13 of the imaging optical system 10 is condensed by the microlens 17 and enters the first photoelectric conversion portion 21 or the second photoelectric conversion portion 22. In this case, light beams that have passed through different regions of the exit pupil 13 mainly enter the first photoelectric conversion portion 21 and the second photoelectric conversion portion 22, as shown in FIGS. 12A and 12B. More specifically, a light beam that has passed through a first pupil region 1210 enters the first photoelectric conversion portion 21, and a light beam that has passed through a second pupil region 1220 enters the second photoelectric conversion portion 22.

When the A signal and the B signal are acquired from each of a plurality of pixels arranged in the horizontal direction with respect to a pixel of interest as the center, the relative positional deviation amount (the phase difference or the parallax amount) between an image signal (A image) based on an A signal train and an image signal (B image) based on a B signal train has a magnitude according to the defocus amount of the pixel of interest.

In FIGS. 12C to 12E, reference numeral 1211 denotes a first light beam that passes through the first pupil region 1210; and 1221, a second light beam that passes through the second pupil region 1220.

FIG. 12C shows an in-focus state, and the first light beam 1211 and the second light beam 1221 are converged on the imaging plane. In this case, the phase difference or the parallax amount between the A image and the B image is 0.

In FIG. 12D, the first light beam 1211 and the second light beam 1221 are converged on the object side (the negative direction side of the z-axis) of the imaging plane. In this case, the phase difference or the parallax amount between the A image and the B image has a negative value (< 0).

In FIG. 12E, the first light beam 1211 and the second light beam 1221 are converged on the far side (the positive direction side of the z-axis) of the imaging plane when viewed from the object side. In this case, the phase difference or the parallax amount between the A image and the B image has a positive value (> 0).

As described above, the phase difference or the parallax amount between the A image and the B image has a sign according to the relationship between the imaging plane and the position at which the first light beam 1211 and the second light beam 1221 are converged and has a magnitude according to the magnitude of the defocus amount. A correlation amount is calculated while relatively shifting the A image and the B image, and the phase difference or the parallax amount between the A image and the B image can be acquired as a deviation amount that maximizes the correlation amount.

### Distance Map Acquisition Processing

The control unit 200 can acquire the range image generated by the processing unit 902 as a distance map to be used to calculate a three-dimensional shape. Also, the control unit 200 and the storage unit 204 can acquire the distance map by reading out the range image recorded in advance.

Distance map generation processing by the processing unit 902 includes processing of calculating a parallax amount, processing of converting the parallax amount into a defocus amount, processing of converting the defocus amount into a distance value, processing of generating a distance map from the distance value, and processing of generating a ranging reliability from a captured image with a parallax. The distance map is limited to an image-based distance map. The image-based distance map is generated by an imaging-plane phase difference detection pixel provided in the image capture apparatus 901. Note that the parallax amount calculation method is not limited, and a stereo camera may be used.

### Depth Map Acquisition Processing

By depth map acquisition processing of the processing unit 902, a depth map is estimated from a captured image. The depth map estimation method is not particularly limited and, as described in the first embodiment, a method using a neural network, the contrast or vanishing point of the captured image, or a subject having a known size can be used.

<Processing of Extraction Unit 300, Coefficient Calculation Unit 301, and Generation Unit 302>

The processing of the extraction unit 300, the processing of the coefficient calculation unit 301, and the processing of the generation unit 302, which are executed in the processing unit 902, will be described with reference to FIGS. 4A to 4D, 5A to 5D, and 13.

Note that processing different from the first embodiment will mainly be described below.

The processing shown in FIGS. 4A to 4D is started when a distance map and a depth map are generated by the image capture apparatus 901.

(Processing of Extraction Unit 300)

In step S300 of FIG. 4A, like the first embodiment, highly reliable data is extracted from the distance map and the depth map.

FIG. 4B is a flowchart exemplifying processing executed in step S300 of FIG. 4A. FIG. 5A is a flowchart exemplifying processing executed in step S400 of FIG. 4B.

In step S500, the extraction unit 300 sets only a highly reliable region derived from the imaging optical system 10 of the image capture apparatus 901, unlike the first embodiment. This is because the image capture apparatus 901 captures various image capture scenes and, therefore, it is impossible to set an assumption for the image capture scenes.

Next, in step S401 of FIG. 4B, the extraction unit 300 extracts a ranging value in an effective ranging range for an effective region extraction distance map extracted in step S400, like the first embodiment. The effective ranging range used in this case is set by an AF evaluation value such as a focal distance calculated when image capture is performed by the image capture apparatus 901, unlike the first embodiment. Also, the effective ranging range may be adjusted in accordance with the ambient environment at the time of image capture, for example, brightness of a captured image or the temperature at the time of image capture.

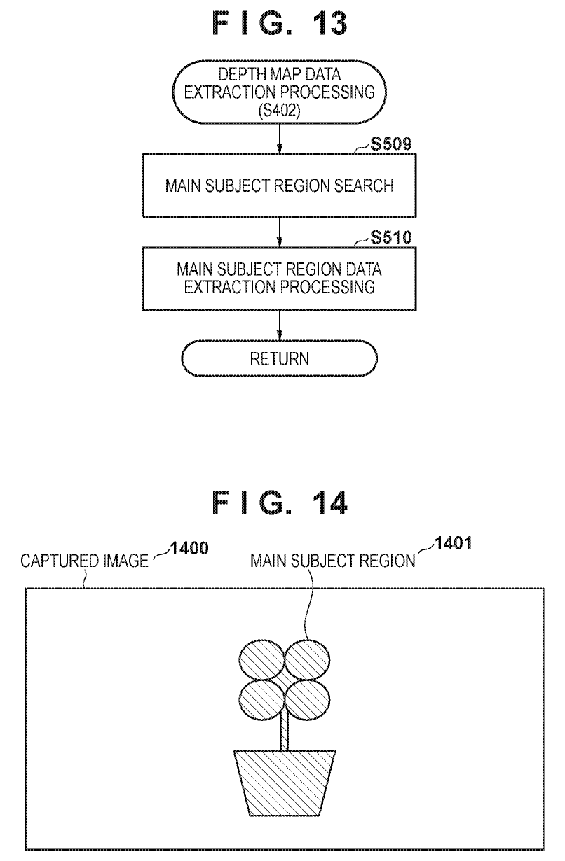

FIG. 13 is a flowchart exemplifying processing of step S402 in FIG. 4B different from the first embodiment.

In step S509, the extraction unit 300 searches for a region having a depth value that can be considered as a main subject from the data of the depth value of the depth map and sets a main subject region.

FIG. 14 is a view illustrating a main subject region setting method in step S509 of FIG. 13.

By the main subject region search method, a main subject region 1401 is detected from a captured image 1400 and set using semantic segmentation (a hatching region in FIG. 14). Note that the main subject region detection method is not limited.

In step S510, the extraction unit 300 extracts the data of the main subject region set in step S509 from the depth map and outputs the extracted data as an extraction depth map.

Next, in step S403 of FIG. 4B, the same processing as in the first embodiment is performed.

(Processing of Coefficient Calculation Unit 301)

In step S301 of FIG. 4A, the same processing as in the first embodiment is performed.

FIG. 4C exemplifies processing executed in step S301 of FIG. 4A.

In step S405, the coefficient calculation unit 301 determines the reliability of a fitting coefficient using a fitting coefficient calculated in step S404 and the threshold of the fitting coefficient, like the first embodiment. After the processing, the calculated coefficient is output as a highly reliable coefficient. The method of setting the threshold of the fitting coefficient used in this case is different from that of the first embodiment, and the threshold is set by the distance map and the depth map acquired by the image capture apparatus 901. As for the threshold of the fitting coefficient, a highly reliable coefficient is set based on an index such as an AF evaluation value such as a focal distance calculated when image capture is performed by the image capture apparatus 901 or the ranging value of a subject located closest in a coefficient handled when scaling the depth map at the subsequent stage.

Processing of Generation Unit 302

In step S302 of FIG. 4A, the same processing as in the first embodiment is performed.

As described above, according to the second embodiment, a dense and accurate distance map can be acquired. As a result, it is possible to blur the main subject background of a captured image or generate a three-dimensional model using the distance map, and various applications are possible.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-082122, filed May 15, 2025 which is hereby incorporated by reference herein in its entirety.

What is claimed is:

1. An information processing apparatus comprising:
at least one processor; and
at least one memory which stores a program which, when executed by the at least one processor, causes the information processing apparatus to function as:
an acquisition unit that acquires a first distance map indicating first distance information corresponding to a position in a captured image and a second distance map indicating second distance information corresponding to a position in the captured image; and
a generation unit that generates a third distance map based on the first distance information of the first distance map and the second distance information of the second distance map.

2. The apparatus according to claim 1, wherein
the first distance map is generated based on distance information acquired from an image pair having a parallax.

3. The apparatus according to claim 1, wherein
the first distance map includes distance information at a coarse position in the captured image, and
the second distance map includes distance information at a dense position in the captured image.

4. The apparatus according to claim 1, wherein the at least one processor functions as:
an extraction unit that extracts the first distance information from the first distance map and extracts the second distance information from the second distance map; and
a calculation unit that calculates a coefficient used to make a scale of the first distance information extracted by the extraction unit match a scale of the second distance information,
wherein the generation unit performs scaling of the first distance information and the second distance information based on the coefficient and generates the third distance map.

5. The apparatus according to claim 4, wherein
the extraction unit extracts the first distance information and the second distance information each of which has reliability not less than a predetermined threshold from the first distance map and the second distance map.

6. The apparatus according to claim 4, wherein
the calculation unit performs fitting of the first distance information and the second distance information using at least one of the first distance information and the second distance information extracted by the extraction unit, thereby calculating the coefficient.

7. The apparatus according to claim 6, wherein
the calculation unit determines reliability of the coefficient using a threshold and repetitively performs calculation of the coefficient until the coefficient falls within a range of the threshold.

8. The apparatus according to claim 1, wherein
the second distance map is generated by inference processing using a trained artificial intelligence (AI) model.

9. The apparatus according to claim 1, wherein
the second distance map is generated by analyzing at least a contrast, a vanishing point, and a size of a subject of the captured image.

10. The apparatus according to claim 4, wherein
the extraction unit extracts, from the first distance map, the first distance information of an effective region in the captured image.

11. The apparatus according to claim 4, wherein
the extraction unit extracts, from the first distance map, the first distance information in an effective ranging range.

12. The apparatus according to claim 4, wherein
the extraction unit extracts distance information in which a local variation of the first distance information is smaller than a predetermined range.

13. The apparatus according to claim 4, wherein
the extraction unit extracts, from the second distance map, the second distance information of a region except for a background region in the captured image.

14. The apparatus according to claim 4, wherein
the extraction unit extracts, from the second distance map, the second distance information of a main subject region in the captured image.

15. The apparatus according to claim 4, wherein
the extraction unit extracts information of a common region in the captured image to the first distance information and the second distance information.

16. The apparatus according to claim 15, wherein
the extraction unit extracts the information of the common region by a logical operation of the first distance information and the second distance information.

17. The apparatus according to claim 15, wherein
the calculation unit determines validity of the information of the common region extracted by the extraction unit and calculates the coefficient using the information of the common region from which information determined as invalid is removed.

18. The apparatus according to claim 17, wherein
the validity is determined using a threshold set based on distance information to a subject in the captured image.

19. The apparatus according to claim 17, wherein
the validity is determined using a threshold set based on an evaluation value of automatic focus control of a subject in the captured image.

20. The apparatus according to claim 1, wherein
the first distance map and the second distance map are acquired from the same captured image of the same viewpoint and the same time.

21. An image capture apparatus comprising:
an information processing apparatus; and
an imaging unit that generates a captured image,
wherein the information processing apparatus comprises:
an acquisition unit that acquires a first distance map indicating first distance information corresponding to a position in a captured image and a second distance map indicating second distance information corresponding to a position in the captured image; and
a generation unit that generates a third distance map based on the first distance information of the first distance map and the second distance information of the second distance map.

22. A moving apparatus comprising:
an information processing apparatus;
an image capture apparatus that generates a captured image; and
a control apparatus that controls the moving apparatus based on a third distance map generated by the information processing apparatus,
wherein the information processing apparatus comprises:
an acquisition unit that acquires a first distance map indicating first distance information corresponding to a position in a captured image and a second distance map indicating second distance information corresponding to a position in the captured image; and
a generation unit that generates a third distance map based on the first distance information of the first distance map and the second distance information of the second distance map.

23. An information processing method executed by an information processing apparatus comprising:
acquiring a first distance map indicating first distance information corresponding to a position in a captured image and a second distance map indicating second distance information corresponding to a position in the captured image; and
generating a third distance map based on the first distance information and the second distance information.

24. A non-transitory computer-readable storage medium storing a program for causing a computer to function as an information processing apparatus comprising:
an acquisition unit that acquires a first distance map indicating first distance information corresponding to a position in a captured image and a second distance map indicating second distance information corresponding to a position in the captured image; and
a generation unit that generates a third distance map based on the first distance information of the first distance map and the second distance information of the second distance map.
